(19) United States
(12) Patent Application Publication
(10) Pub. No.: US 2019/0073877 A1
(43) Pub. Date: Mar. 7, 2019

(54) PULL-TAB GAMING SYSTEM AND METHOD OF OPERATION

(71) Applicant: Creative Game Technologies, LLC, Columbus, OH (US)

(72) Inventors: Alfred S. DELEON, Daniel Island, SC (US); Joseph DELEON, New York, NY (US); Ronel ALFONSO, Bradford (CA)

(73) Assignee: Creative Game Technologies, LLC, Columbus, OH (US)

(21) Appl. No.: 16/123,345

(22) Filed: Sep. 6, 2018

Related U.S. Application Data
(60) Provisional application No. 62/554,908, filed on Sep. 6, 2017.

(51) Int. Cl. G07F 17/32; G06Q 50/34

(52) U.S. Cl. CPC G07F 17/3267; G06Q 50/34; G07F 17/3209; G07F 17/3211

(57) ABSTRACT

A pull-tab game system includes a terminal configured to allow and facilitate a player's participation in a pull-tab game. The pull-tab game including a first round and an additional round. The terminal is configured to display to the player the outcome of the first round and whether the player is eligible to participate in the additional round. The terminal is configured to produce a ticket for the player to use to register for the additional round. The terminal is further configured to register the ticket prior to conducting a drawing for the additional round.

### CROSS REFERENCE TO RELATED APPLICATION

This application claims benefit of U.S. Provisional Application Ser. No. 62/554,908, filed Sep. 6, 2017, the entire disclosure of which is incorporated herein.

### TECHNICAL FIELD

This disclosure relates to gaming systems, and specifically relates to electronic gaming systems and methods of use of the electronic gaming systems.

### BACKGROUND

A traditional pull-tab game system includes a large number of tickets. Each of the tickets includes a number of indicia on a surface of the ticket. The indicia printed on the ticket correlate to an outcome of the game. Some of the tickets include indicia that correlate to winning a prize, and others of the tickets include indicia that correlate to no prize. The ticket further includes a removable tab that covers the indicia and at least a portion of the surface. Prior to a player purchasing a ticket, the removable tab prevents the outcome that the ticket correlates to from being known. After a player purchases a ticket, the player can remove the tab, reveal the indicia, and reveal the indicia and the outcome of the ticket. If the ticket correlates to a prize, the player can then redeem the prize.

Pull-tab game systems include physical versions in which the player purchases a physical ticket and manually removes the tabs to reveal the indicia. Pull-tab game systems also include electronic versions in which the player purchases a digital ticket and the tabs are then removed electronically to reveal the indicia.

### SUMMARY

A pull-tab game system is configured to allow a player to play a game. The system is configured to receive a payment from the player, and the system includes a terminal configured to begin playing the game. The terminal 202 may communicate with a server of the pull-tab game system to retrieve a pull-tab ticket from a plurality of tickets stored at the server. Each ticket may have an associated outcome, and the terminal may include a display configured to visualize an associated outcome of a selected ticket. In embodiments, upon receiving a request for a ticket from the terminal, the server may be configured to determine a second outcome associated with the selected ticket, wherein the second outcome is independent of the first outcome.

In embodiments, tickets may be pull-tab tickets. The tickets may include a potential prize for the game and a potential entry to a second game. The terminal may be configured to receive the pull-tab ticket and the ticket outcome from the server and display the results of the first outcome. The terminal may also be configured to visualize the first outcome upon receiving an input from a player. In embodiments, visualizing outcomes may comprise revealing one or more indicia corresponding to the associated outcome. The terminal is further configured to display whether the pull-tab ticket is eligible for entry to the second game. The terminal may also print a ticket to be collected by the player 100 and used for entry to the second game.

The system is configured to identify and register the ticket at a time different from the time of the first game. Additionally, the system is configured to designate some of the tickets as eligible for entry to a third game. In other embodiments, the terminal is configured to displays which tickets are eligible for entry to the third game and print bonus tickets to be collected by the players eligible for the third game. The system is configured to identify and register the bonus tickets at a time different from the time of the second game. The system is configured to associate an outcome with each of the registered bonus tickets.

In embodiments, the system may register one or more of the bonus tickets, assign a third outcome to each of the registered tickets, determine, at the server, a fourth outcome of each of the registered tickets, the fourth outcome being positive or negative, and output an entry to a third round of the game associated with each of the registered tickets having a positive outcome. The entry may be the registered ticket, or a distinctive ticket different from the registered ticket associated with the positive outcome. In addition, the terminal may register one or more entries to the third round of the game, and assign a fifth outcome to each of the registered entries.

### BRIEF DESCRIPTION OF THE DRAWINGS

The foregoing summary, as well as the following detailed description of illustrative embodiments of the application, will be better understood when read in conjunction with the appended drawings. For the purposes of illustrating the present disclosure, there is shown in the drawings illustrative embodiments. It should be understood, however, that the application is not limited to the specific embodiments and methods disclosed, and reference is made to the claims for that purpose. In the drawings:

FIG. 1 is a front elevation view of a game terminal according to one aspect of the disclosure;

FIG. 2 is a flow chart of a first round of a pull-tab game according to one aspect of the disclosure;

FIG. 3 is a flow chart of server used in a pull-tab game according to one aspect of the disclosure;

FIG. 4 is a flow chart of a second round of a pull tab game according to one aspect of the disclosure;

FIG. 5 is a flow chart of a third round of a pull tab game according to one aspect of the disclosure;

FIG. 6 is a flow chart of a pull tab game system according to one aspect of the disclosure; and

FIG. 7 is a block diagram of a computer system in which aspects of the disclosed pull-tab game, pull-tab game system, and methods of playing the pull-tab game may be operated.

### DETAILED DESCRIPTION OF ILLUSTRATIVE EMBODIMENTS

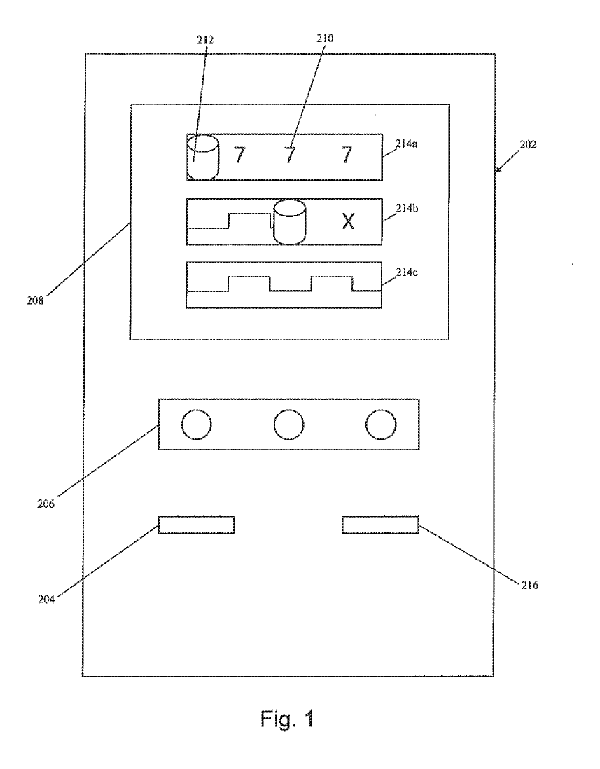

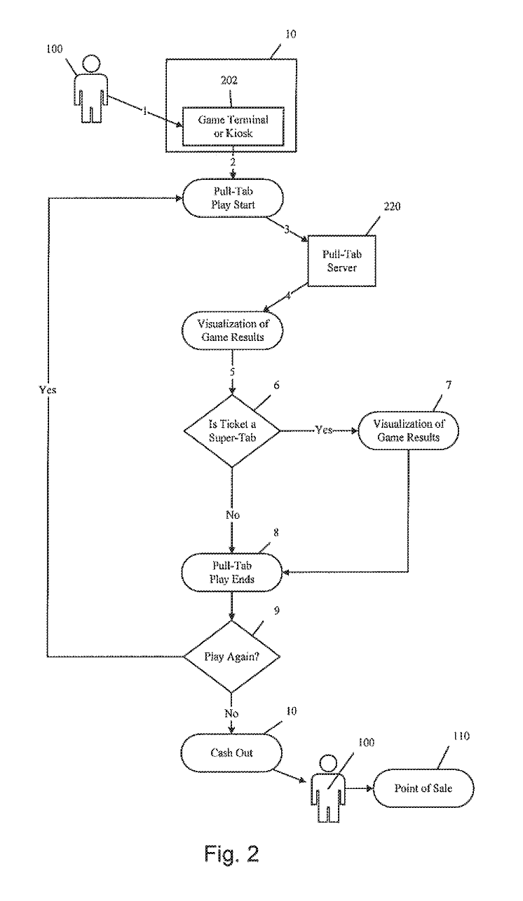

Referring to FIGS. 1 and 2, a pull-tab game system 200 (hereinafter system 200) includes a pull-tab game terminal 202 (hereinafter the terminal 202) through which a player may play one or more games in accordance with embodiments described herein. The terminal 202 may be placed at a location 10 accessible to a player, such as a casino or building that a player 100 may enter. The terminal may be in communication with a server 220, at least one of the server 220 and the terminal 220 may determine outcomes of the game.

The system 200 may include terminals 202 of various configuration including but not limited to: a cabinet, a tablet, and an all-in-one. The cabinet terminal may include a display, such as a touch screen monitor, a ticket printer, a ticket reader, or any combination thereof. The tablet terminal may include a touch screen monitor configured to receive user input. The all-in-one terminal may include a display, which may or may not be a touch screen configured to receive user input, and at least one input device, such as a mouse. Terminals may comprise one or more receptacles 204, 216 in which a player may input or receive one or more items relating to a game play, such as money or a ticket. Terminals may further comprise a display 208 on which gameplay may be visualized, and input controls 206 through which the player may use to initiate and operate the game play. In some embodiments, the terminal 202 may include a touchscreen. The touchscreen may provide both the visual display 208 and input controls 206 through which the player may select one or more options relating to gameplay.

In embodiments, the system 200 may be a kiosk at which the player 100 may insert money and receive a ticket through the one or more receptacles 204, 216. The ticket may include an account number, and the terminal 202 may be configured to accept the account number to enable the player 100 to start the game.

At step 1, the player 100 initiates a play of a pull-tab game (hereinafter the game). This initiating step may include inserting a payment into the terminal 202. The payment may include, but is not limited to, cash, tokens, a credit card, and the like. As shown in the illustrated embodiment the terminal 202 may include a receptacle 204 configured to receive the payment.

After the payment is received, the game starts at step 2. The player 100 may initiate the start of the game, for example through an input applied to controls 206 of the terminal 202. The controls 206 may include a physical apparatus, such as buttons, knobs, etc. The controls 206 may also be electronic, for example, the terminal 202 includes a display 208, which will be described in additional detail below. The display 208 may include a touch screen, which functions as the controls 204 and may be configured to start the game. Alternatively, the terminal 202 may initiate the start of the game automatically once the payment is received.

The system 200 may include a pull-tab server 220 (hereinafter server 220) configured to communicate with the one or more terminals in accordance with one or more gaming systems, steps, operations, and embodiments, as described herein. The server 200 may make determinations regarding the outcomes of the games and a selection of tickets and other aspects of the gameplay. The pull-tab server 220 may be located remotely from the terminal 202, or alternatively within the terminal 202 itself. The server 220 may communicate with the one or more terminals via network communication, or direct communication, for example. According to one aspect of the disclosure, the server 220 is located at a same location 10 as the terminal. In an example, the server 220 may be within the same building or place of business as the terminal, in close proximity to the terminal, or in a different room. In one embodiment, the server 220 may be in communication with one terminal 202. In another embodiment, the server 220 may be in communication with a plurality of terminals 202, which may each be present at the same location 10, or present at a plurality of locations 10.

According to an aspect of the disclosure, after the game is started, the terminal 202 may request a pull-tab ticket from the server 220 at step 3. Upon receipt of the request for a pull-tab ticket from the terminal 202, the server may make a determination to send a pull-tab ticket to the terminal 202 at step 4. The display 208 of the terminal 202 may visualize the outcome of the pull-tab ticket so the player 100 sees the outcome. The outcome of the ticket may be displayed in numerous formats. According to one aspect of the disclosure, the display 208 may be configured to display indicia 210, such as numbers, letters, symbols, colors, or any combination thereof. The indicia 210 may be covered by a pull-tab 212, which upon removal reveals the indicia 210. As shown in the illustrated embodiment, the indicia 210 may include multiple rows of indicia 210, including, for example, a first row of indicia 214a, a second row of indicia 214b, and a third row of indicia 214c. The terminal 202 may be configured to remove each of the pull-tabs 212 covering the rows of indicia 214 upon receipt of an input from the player 100. In other embodiments, the terminal 202 may be configured to automatically remove each of the pull-tabs upon receipt and display of the ticket. After all of the pull-tabs 212 are removed, the terminal 202 displays the outcome that correlates to the revealed indicia 210 at step 5.

The revealing of the indicia 210 and the associated outcome constitutes one round of the game. In addition to the outcome of the first round of the game, the pull-tab ticket sent by the server 220 may include an outcome for a second round of the game. When the pull-tab ticket is requested by the terminal 202, the server 220 determines whether to send a pull-tab ticket, and if so, determines the outcome to the first round of the game, and whether the pull-tab ticket wins the second round of the game. In an embodiment, a pull-tab ticket identified as one that wins the second round of the game may be referred to as a SuperTab. The terminal 202 may further configured to visualize to the player 100 whether the pull-tab ticket is a SuperTab. The visualization may, for example, be displayed upon receipt of the pull-tab ticket, throughout one or more rounds of gameplay, or after a round of the game has been completed.

Step 6 of FIG. 2 illustrates that the terminal may check the pull-tab ticket to see if it is a SuperTab. If the pull-tab ticket is not a SuperTab, the game ends. If the pull-tab ticket is a SuperTab, the terminal 202 may display the outcome that the pull-tab ticket is a SuperTab to the player 100. In one embodiment, the terminal 202 may include a receptacle 216 configured to output a SuperTab ticket or other ticket indicative of the displayed SuperTab ticket outcome for the player 100 to collect. According to one aspect of the disclosure, the receptacle 216 is separate from the receptacle 204, which receives payment. Alternatively, the receptacle 216 may be the same receptacle as the receptacle 204.

A SuperTab is a way to identify some of the pull-tab tickets in the pool of tickets as special tickets. According to one embodiment, the value of the pull-tab ticket does not change when it is identified as a SuperTab. The SuperTab is played as a normal pull-tab would be through the first round of play. In embodiments, the SuperTab may be eligible for use in at least one separate game (or round of game), in which the SuperTab will be assigned a new value, different from the original value assigned to the SuperTab in the first round of the game. In an embodiment, when the SuperTab is used in a new game, the terminal upon which the new game is played may communicate with server 220 to determine the new value of the SuperTab.

Referring back to FIG. 2, when a ticket is identified as a SuperTab, the terminal visualizes the game results, at step 7. This may be similar to the visualization of the first round of the game. For example, the display may visualize revealing one or more rows of indicia on the SuperTab ticket, and subsequently display the outcome corresponding to the revealed indicia. After the visualization of the SuperTab outcome, the second round of the game ends at step 8. The player 100 may decide to play again at step 9, or decline to play again and cash out if the player 100 has accumulated any prizes. In an embodiment, the display may visualize the option for the player to determine whether to play again. The user may use input terminals 206, e.g., physical input terminal buttons and/or a touch screen display, to indicate his/her determination of whether to play again. If the player chooses to play again, a new game may begin. If a player decides not to play again, the player may cash out and receive a ticket, card, credit, or other physical or virtual indication or receipt of any winnings accumulated. The player 100 may then collect his/her winnings at a point of sale 110.

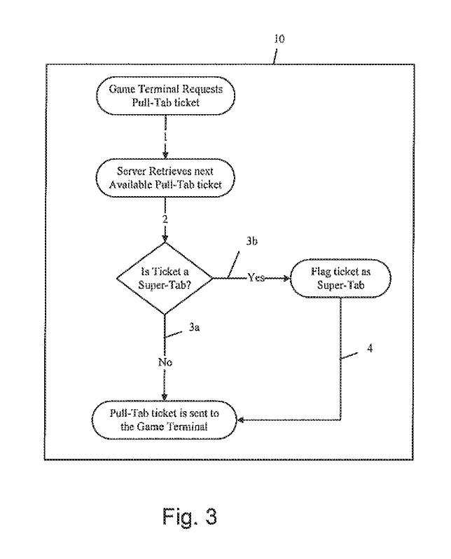

FIG. 3 illustrates an example operational flow chart for when the terminal 202 requests a pull-tab ticket. Upon receipt of the request, the server 220 may retrieve a next available pull-tab ticket from a pool of pull-tab tickets. The pool of pull-tabs may be stored at the server. The server 220 may then determine if the selected pull-tab ticket qualifies to be a SuperTab. If the pull-tab ticket qualifies to be a SuperTab, the server 220 then determines whether the pull-tab ticket is a SuperTab. A determination of whether pull-tab ticket qualifies to be a SuperTab may be based on one or more factors. For example, the determination may be based, at least in part, on the denomination of the purchased pull-tab ticket, and a number of players 100 at the location 10. According to one aspect of the disclosure, the player 100 cannot influence whether a pull-tab ticket is a SuperTab. The server 220 randomly determines which of the retrieved qualifying pull-tab tickets is a SuperTab. According to one aspect of the disclosure, the steps involved in determining if a ticket is a SuperTab may all be performed at the location 10.

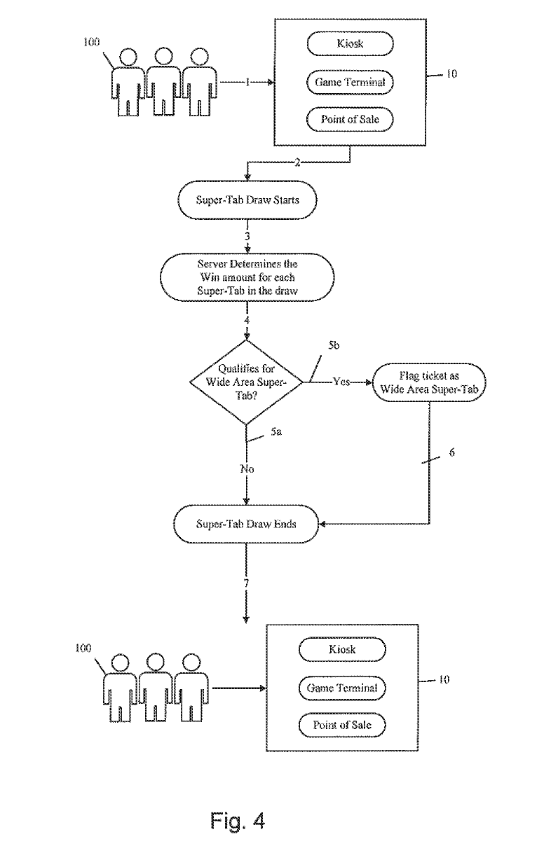

FIG. 4 illustrates an example game play for SuperTabs. In FIG. 4, when a player 100 receives a pull-tab ticket that is a SuperTab, the player 100 is eligible for an additional round of the game. At step 1, any players 100 that received a SuperTab from the terminal 202 show up at the location 10 at a designated time. The designated time may be a different time, for example a different day, than the day the player 100 participated in the first and second rounds of the game. According to one aspect of the disclosure, a SuperTab drawing may take place weekly at a given location 10. At step 2, any players 100 with SuperTabs register the SuperTabs at the location 10. According to one aspect of the disclosure, the terminal 202 may be configured to identify and register all of the SuperTabs awarded to players 100 at the location 10. The terminal 202 may include a scanner or reader configured to identify the SuperTabs present at the location 10.

At step 3, the SuperTab drawing begins. At step 4, the system 200, for example the server 220, determines an outcome for each of the SuperTabs registered at the location 10 at the time the SuperTab drawing begins. The terminal 202 is configured to display results of the SuperTab drawing and prizes associated with the registered SuperTabs.

In addition to the outcome of the third round of the game, the registered SuperTab are also checked for an outcome for a fourth round of the game. During the SuperTab drawing, the server 220 is configured to determine which, if any, of the SuperTabs win the fourth round of the game. A SuperTab identified as one that wins the fourth round of the game may be referred to as a Wide Area SuperTab. A Wide Area SuperTab is eligible to be used in a separate game (or an additional round of the current game), in which the Wide Area SuperTab will be assigned a new value, different from the value assigned to the Wide Area SuperTab in the SuperTab drawing. The separate game (or additional round) associated with the Wide Area SuperTab may include SuperTab tickets identified as Wide Area SuperTabs from a plurality of locations 10. The terminal 202 is further configured to visualize to the player 100 which of the SuperTabs is a Wide Area SuperTab.

At step 5, the terminal checks the SuperTab to determine whether it is a Wide Area SuperTab. If the SuperTab ticket is not a Wide Area SuperTab, the game ends at step 5a. If the SuperTab is a Wide Area SuperTab, the terminal 202 displays the outcome that the SuperTab is a Wide Area SuperTab to the player 100. The terminal 202 may be configured to output the Wide Area SuperTab through the receptacle 216. After the visualization of the Wide Area SuperTab outcome, the third round of the game ends at step 6. The player 100 may cash out if the player 100 has accumulated any prizes at step 7.

Because the SuperTabs are given randomly to the player 100, the players 100 are not required to make any extra contributions or payments to be eligible for the prizes in the SuperTab drawing.

The value of the SuperTab, according to one aspect of the disclosure, is calculated based at least partially on the number of pull-tab tickets sold during a previous period of time. Alternatively, the SuperTab may have a predetermined prize. According to one aspect of the disclosure the pull-tab game is designed to have a return to player of a predetermined percentage (J %). The value of all the SuperTabs may be calculated to be a portion C % of the predetermined percentage, and the value of the non-SuperTabs may be calculated to be a portion G % of the predetermined percentage, such that C % plus G % equals J %.

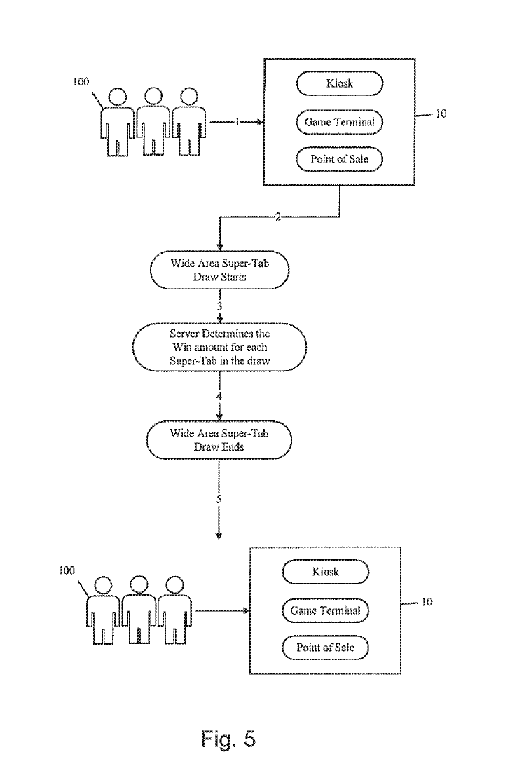

Referring to FIG. 5, when a player 100 receives a Wide Area SuperTab, the player 100 is eligible for a fourth round of the game. At step 1, any players 100 that received a Wide Area SuperTab from any of the terminals 202 of the system 200 show up at a wide area location 10 at a designated time. According to one aspect of the disclosure, a Wide Area SuperTab drawing may take place monthly at a given location 10. The wide area location 10 may be the same location 10 the player 100 participated in the first, second, and third rounds. Alternatively, the wide area location 10 may be different from the location 10 the player 100 participated in the first, second, and third rounds. The players 100 for the Wide Area SuperTab drawing may include winning tickets from various locations 10. The designated time may be a different time than the time the player 100 participated in the first, second, and third rounds of the game.

At step 2, any players 100 with Wide Area SuperTabs register the Wide Area SuperTabs at the wide area location 10. According to one aspect of the disclosure, the terminal 202 may be configured to identify and register all of the Wide Area SuperTabs awarded to players 100. The terminal 202 may include a scanner or reader configured to identify the Wide Area SuperTabs present at the location 10.

At step 3, the Wide Area SuperTab drawing begins. At step 4, the system 200, for example the server 220, determines an outcome for each of the Wide Area SuperTabs registered at the location 10 at the time the Wide Area SuperTab drawing begins. The terminal 202 is configured to display results of the Wide Area SuperTab drawing and prizes associated with the registered Wide Area SuperTabs. After the visualization of the Wide Area SuperTab outcome, the game ends at step 5. The player 100 may cash out if the player 100 has accumulated any prizes at step 6.

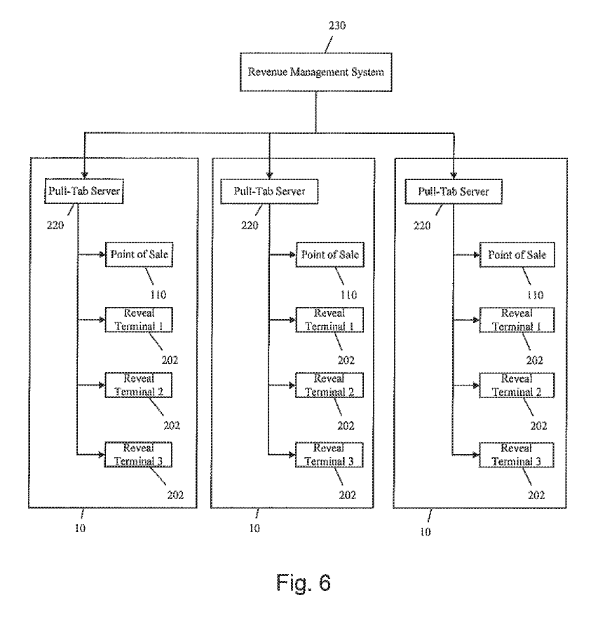

Referring to FIG. 6, the system 200 may include a plurality of servers 220. Each of the servers 220 may be located at a location 10, and connected to one or more terminals 202 located at the location 10. The system 200 may further include a revenue management system 230 configured to collect play activity summaries for each location 10, server 220, point of sale 110, terminal 202, or any combination thereof. The revenue management system 230 may further be configured to manage software licensing at each of the locations 10.

Referring to FIGS. 1 to 6, the system 200 is configured to allow a player 100 to play a game. The player 100 deposits a payment and then begins playing the game at a terminal 202. The terminal 202 communicates with the server 220 to retrieve a pull-tab ticket. The pull-tab ticket includes a potential prize for a first round of play and a potential entry to an additional round of play. The terminal 202 receives the pull-tab ticket from the server 220 and displays the results of the first round of play, usually as a plurality of indicia 210. The terminal 202 further displays if the pull-tab ticket is a SuperTab and thus eligible for an additional round of the game. The terminal 202 then prints the SuperTab to be collected by the player 100.

The player 100 returns to the terminal 202 at a designated time for a SuperTab drawing. The player registers their SuperTab prior to the SuperTab drawing. The terminal 202 may be configured to identify and register the SuperTab. At the time of the SuperTab drawing the server 220 designates prizes for each of the SuperTabs. Additionally, the server 220 may designate some of the SuperTabs as Wide Area SuperTabs. The terminal 202 further displays which SuperTabs are Wide Area SuperTabs and thus eligible for an additional round of the game. The terminal 202 then prints the Wide Area SuperTab (or returns the SuperTab) to be collected by the player 100.

The player 100 travels to a terminal 202 of the system 200 at a designated time for a Wide Area SuperTab drawing. The player registers their Wide Area SuperTab prior to the Wide Area SuperTab drawing. The terminal 202 may be configured to identify and register the Wide Area SuperTab. At the time of the Wide Area SuperTab drawing the server 220 designates prizes for each of the SuperTabs.

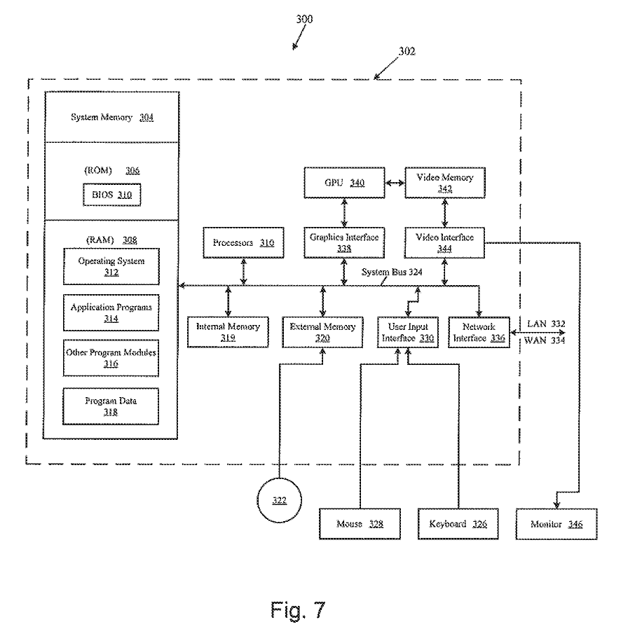

Referring now to FIG. 7, a block diagram of an example computer system 300 on which the embodiments described herein and/or various components thereof, such as the terminal 202 and the server 220 may be implemented. For example, the functions performed by the system 200 described in the various embodiments above may be performed by one or more such example computer systems. For example, the system described herein may be implemented in software (i.e., computer executable instructions or program code) executing on one or more such computer systems 300. It is understood, however, that the computer system 300 is just one example of a suitable computing environment and is not intended to suggest any limitation as to the scope of use or functionality of the presently disclosed subject matter. Neither should the computer system 300 be interpreted as having any dependency or requirement relating to any one or combination of components illustrated in FIGS. 1 to 6.

For example, the components used in this description may include specialized hardware components configured to perform functions by firmware or switches. In other example embodiments, components may include a general-purpose processor, memory, etc., configured by software instructions that embody logic operable to perform functions. In example embodiments where modules or components include a combination of hardware and software, an implementer may write source code embodying logic and the source code may be compiled into machine-readable code that can be processed by the general-purpose processor.

Since the state of the art has evolved to a point where there is little difference between hardware, software, or a combination of hardware and software, the selection of hardware versus software to effect specific functions is a design choice left to the user. More specifically, a software process may be transformed into an equivalent hardware structure, and a hardware structure may itself be transformed into an equivalent software process. Thus, the selection of a hardware implementation versus a software implementation is one of design choice and left to the user.

In FIG. 7, the computer system 300 includes a computer 302, which may include a variety of computer-readable media. Computer-readable media may be available media that may be accessed by the computer 302. The computer 300 includes system memory 304, which may include computer storage media in the form of read only memory (ROM) 306 and random access memory (RAM) 308. A basic input/output system 310 (BIOS), containing the basic routines that help to transfer information between elements within computer 302, such as during start-up, may be stored in ROM 306. The RAM 308 may contain data and/or program modules that are immediately accessible to and/or presently being operated on by processors 310. By way of example, and not limitation, FIG. 7 illustrates an operating system 312, application programs 314, other program modules 316, and program data 318.

The computer 302 may also include internal memory 319, external memory 320, or both that read from or writes to non-removable, nonvolatile magnetic media; removable, nonvolatile optical disk 653 such as a CD ROM 322 or other optical media. Other removable/non-removable, volatile/nonvolatile computer storage media that can be used in the exemplary operating environment include, but are not limited to, magnetic tape cassettes, solid-state drives, flash memory cards, digital versatile disks, digital video tape, solid state RAM, solid state ROM, and the like. The external memory 320 may be connected to a system bus 324 of the computer 302. The drives and their associated computer storage media discussed herein may provide storage of computer-readable instructions, data structures, program modules and other data for the computer 302.

A user may enter commands and information into the computer 302 through input devices such as a keyboard 326 and a mouse 328, trackball, or touch pad. These and other input devices may be connected to the processors 310 through a user input interface 330 that is coupled to the system bus 324, but may be connected by other interface and/or bus structures, such as a parallel port, game port, or a universal serial bus (USB) for example. The computer may connect to a local area network or wide area network, such as LAN 332 and/or WAN 334, through a network interface or adapter 336.

Information in the computer 302 can be entered in the graphics interface 338, processed by the GPU 340, stored in the video memory 342, and output through a video interface 344 to a monitor 346.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as a magnetic, electrical, or optical storage medium, including without limitation a floppy diskette, CD-ROM, CD-RW, DVD-ROM, DVD-RAM, magnetic tape, flash memory, solid-state drive, hard disk drive, or any other machine-readable storage medium, wherein, when the program code is loaded into and executed by a machine, such as a computer or server, the machine becomes an apparatus for practicing the invention.

A computer on which the program code executes may include a processor, a storage medium readable by the processor (including volatile and/or nonvolatile memory and/or storage elements), at least one input device, and/or at least one output device. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits. As used herein, the terms “computer-readable medium” and “computer-readable storage medium” refer to physical, non-transitory storage media and do not encompass transitory media, such as signals.

It will be appreciated that the foregoing description provides examples of the disclosed system and methods. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. All methods described herein can be performed in any suitable order unless otherwise indicated herein or otherwise clearly contradicted by context.

Although the disclosure has been described in detail, it should be understood that various changes, substitutions, and alterations could be made herein without departing from the spirit and scope of the invention as defined by the appended claims. Moreover, the scope of the present disclosure is not intended to be limited to the particular embodiments described in the specification. As one of ordinary skill in the art will readily appreciate from the disclosure of the present invention, processes, machines, manufacture, composition of matter, means, methods, or steps, presently existing or later to be developed that perform substantially the same function or achieve substantially the same result as the corresponding embodiments described herein may be utilized according to the present disclosure.

What is claimed:

1. A gaming system comprising:
a server storing a plurality of tickets, each of the plurality of tickets having a first outcome associated with the ticket, the server configured to select one of the plurality of tickets upon a request for a ticket;
a terminal configured to communicate with the server and request one of the plurality of tickets from the server, the terminal configured to retrieve the ticket from the server, the terminal including a display configured to visualize the first outcome;
wherein upon receiving a request for a ticket from the terminal, the server is configured to determine a second outcome associated with the selected ticket, the second outcome being independent of the first outcome.

2. The gaming system of claim 1, wherein the tickets are pull-tab tickets.

3. The gaming system of claim 1, wherein after retrieving the ticket from the server, the terminal is further configured to at least visualize the first outcome upon receiving an input from a player.

4. The gaming system of claim 1, wherein after the server determines the second outcome, the terminal is configured to at least visualize the second outcome.

5. The gaming system of claim 1, wherein visualizing the first outcome comprises revealing one or more indicia corresponding to the first outcome.

6. The gaming system of claim 1, wherein the server is located at a same place of business as the terminal.

7. The gaming system of claim 1, wherein the server is configured to determine the first outcome associated with each of the plurality of tickets.

8. A gaming terminal comprising:
at least one control configured to receive input from a player to start a first round of a game;
a display configured to visualize a first outcome of the first round of the game, the display further configured to visualize a second outcome of the first round of the game, wherein the second outcome is either positive or negative;
at least one receptacle configured to output a ticket if the second outcome is positive;
wherein the terminal is configured to register the ticket for entry to a second round of the game prior to starting the second round.

9. The gaming terminal of claim 8, wherein the display comprises a touch screen for receiving input from the player.

10. The gaming terminal of claim 8, wherein visualizing the first outcome comprises revealing one or more indicia corresponding to the first outcome.

11. The gaming terminal of claim 8, wherein at least one receptacle is configured to receive a payment as input to start the first round of the game.

12. The gaming terminal of claim 8, wherein the terminal is in communication with a server to receive information indicative of the first and second outcome, the server determining the first and second outcome of the game.

13. A computer-implemented method for playing a game, the method comprising the steps of:
receiving, by a terminal, an input from a player to start a first round of the game;
requesting, by the terminal, a ticket from a plurality of tickets stored on a server;
selecting, by the server, one of the plurality of tickets, the selected one of the plurality of tickets having a first outcome associated with the first round of the game;
determining, by the server, a second outcome of the selected one of the plurality of tickets associated with the first round of the game, wherein the second outcome is either positive or negative;
visualizing, on the terminal, the first outcome and the second outcome; and
if the second outcome is positive, outputting, by the terminal, a special ticket configured to permit entry to a second round of the game.

14. The computer-implemented method of claim 13, further comprising:
registering, by the terminal, one or more of the special tickets;
assigning a third outcome to each of the registered special tickets;
determining, by the server, a fourth outcome of each of the registered special tickets, wherein the fourth outcome is either positive or negative;
outputting, by the terminal, an entry to a third round of the game associated with each of the registered special tickets determined to have a positive fourth outcome

15. The computer implemented method of claim 14, wherein the entry is the registered special ticket associated with the fourth positive outcome.

16. The computer-implemented method of claim 14, wherein the entry is a distinctive ticket different from the registered special ticket associated with the fourth positive outcome.

17. The computer-implemented method of claim 14, further comprising the steps of:
registering, by the terminal, one or more of the entries to the third round of the game; and
assigning a fifth outcome to each of the registered entries.

18. The computer-implemented method of claim 13, wherein the first outcome is an amount of winnings associated with the ticket.

19. The computer-implemented method of claim 13, wherein the visualizing occurs on a display associated with the terminal.

20. The computer-implemented method of claim 13, wherein determining the second outcome is based on one or more of: a denomination of the ticket, and a number of players.
